(19) United States
(12) Patent Application Publication
(10) Pub. No.: US 2026/0225276 A1
(43) Pub. Date: Aug. 6, 2026

(54) PACKAGING MACHINE

(71) Applicant: ULMA Packaging, S.Coop., Oñati (ES)

(72) Inventors: Nicolas ARREGUI ARAMBARRI, Oñati (ES); Jon Ander LEIBAR LARRAÑAGA, Oñati (ES); Eneko IZQUIERDO EREÑO, Oñati (ES)

(21) Appl. No.: 19/453,493

(22) Filed: Jan. 20, 2026

(30) Foreign Application Priority Data
Jan. 31, 2025 (EP) 25382068.2

(51) Int. Cl. B26D 1/157; B26D 7/00; B26D 7/26; B65B 61/08

(52) U.S. Cl. CPC B26D 1/1575; B26D 7/2635; B65B 61/08; B26D 2007/0012

(57) ABSTRACT

A packaging machine including a cutting assembly configured to longitudinally cut a film. The cutting assembly includes a rotary shaft, a cutting disc associated with the rotary shaft with the possibility of axial displacement, an auxiliary member configured to cooperate with the cutting disc to cut the film, and a mechanism configured to cause axial displacement of the cutting disc. The mechanism includes a first element attached to the cutting disc, a second element attached to the rotary shaft, and a chamber confined between the first and second elements. Pressure inside the chamber is adjustable to cause a displacement of the cutting disc.

### CROSS-REFERENCE TO RELATED APPLICATIONS

This application relates to and claims the benefit and priority to European Patent Application No. 25382068.2, filed Jan. 31, 2025, which is incorporated herein by reference in its entirety.

### TECHNICAL FIELD

The present invention relates to packaging machines comprising a cutting assembly for longitudinally cutting at least one continuous film as the film moves in a forward direction.

### BACKGROUND

Some packaging machines comprise a cutting assembly for cutting a continuous film longitudinally as the film moves in a forward direction. The longitudinal cut can be used to remove at least part of the excess film on one side of the cut, or to physically separate two packages or two package cavities that are adjacent in a direction transverse to the forward direction.

The cutting assembly comprises a cutting disc and an auxiliary member which cooperate with each other to cut the film and is arranged in the machine in such a way that, during the advancement of the film in the forward direction, the film passes between the cutting disc and the auxiliary member of the cutting assembly. At least the cutting disc is a blade which cooperates with the auxiliary member, and which rotates with respect to a rotary shaft during the advancement of the film so that the cut is made with such cooperation.

In order to achieve a good cutting quality, it is important that an axial distance between the cutting disc and the auxiliary member and the contact pressure exerted on the film between the cutting disc and the auxiliary member are correctly adjusted. It is common to adjust this distance and pressure by moving axially, and manually, at least one of the elements between the cutting disc and the auxiliary member. This type of adjustment has the risk that an operator may be injured by touching at least the cutting disc or may accidentally damage the cutting disc by contacting it improperly against the auxiliary member during installation/uninstallation, requiring an adjustment time that impairs the productivity of the machine.

US2022355505A1 discloses a solution for adjusting the distance between the two cutting elements, which is safer for the operator. In this solution the cutting assembly comprises a positioning mechanism to cause a relative axial displacement between the cutting disc and the auxiliary member without the need for the operator to manually operate on either of them. The positioning mechanism can be manually operated, in which case it is located away from the cutting disc and the auxiliary member to reduce the risk of the operator contacting either of them, or it can be motor-driven.

### SUMMARY

Disclosed is a packaging machine that comprises a cutting assembly configured to cut longitudinally at least one continuous film during movement of the film in a forward direction. The cutting assembly comprises a rotary shaft with a longitudinal axis that is transverse to the forward direction, at least one cutting disc associated with the rotary shaft with the possibility of axial displacement with respect to the rotary shaft between an inactive position and an active position, and at least one auxiliary member configured to cooperate with the cutting disc when the cutting disc is in the active position. With the cooperation of the cutting disc and the auxiliary member, the film is cut longitudinally as the film moves in the forward direction. The cutting is configured so that the cutting disc rotates together with the rotary shaft with respect to the longitudinal axis at least as the film moves in the forward direction and the cutting is carried out.

The cutting further comprises a positioning mechanism configured to cause an axial displacement of the cutting disc with respect to the rotary shaft, which enables the cutting disc to be positioned in the active position when required and the required contact pressure to be exerted on the film between the cutting disc and the auxiliary member to cut the film correctly.

The positioning mechanism comprises a first positioning member and a second positioning member. The first positioning member is associated with the second positioning member with the possibility of axial displacement relative to the rotary shaft and such that it rotates together with the second positioning member when the rotary shaft rotates and is attached to the cutting disc in such a way that the first positioning member and the cutting disc move axially relative to the rotary shaft together. The second positioning member is attached to the rotary shaft in such a way that it rotates together with the rotary shaft when the rotary shaft rotates and preferably is attached to the rotary shaft without the possibility of axial displacement with respect to the rotary shaft.

The positioning mechanism further comprises at least one chamber confined between at least the first positioning member and the second positioning member, and the cutting assembly comprises actuating means configured to cause axial displacement of the cutting disc with respect to the second positioning member, and thus with respect to the rotary shaft, at least to move from the inactive position to the active position when actuated, by changing the pressure inside the chamber. For example, if the pressure inside the chamber is increased, a force exerted by the fluid on the two positioning members is increased in opposite directions, and this force causes the relative axial displacement between the two positioning members, in particular the axial displacement of the first positioning member, which is the one that has the possibility of axial displacement, the cutting disc being displaced axially. If the pressure inside the chamber is reduced, this could cause the axial displacement of the first positioning member in the opposite direction.

Thus, in the proposed machine, the cutting disc can be brought to the active position in a simple way, simply by modifying the pressure exerted by the fluid in the chamber, in such a way as to ensure the required contact pressure that the cutting disc and auxiliary member exert on the film throughout the useful life of the machine when the cutting disc is in the active position, as the pressure exerted by the fluid in the active position of the cutting disc is not affected by wear and tear on the adjustment mechanism components, resulting in a more durable, reliable and accurate machine. For the same reason, the machine does not require any manual adjustment by the operator, the adjustment work and the adjustment times being facilitated, thus achieving a greater availability of the machine as well.

In addition, the machine can compensate for the consequences of cutting disc wear by regulating the pressure in the chamber, thus enabling higher productivity and lower maintenance costs associated with fewer replacements of the cutting disc.

Additionally, by using a fluid instead of a mechanical activation, a reduction in the number of elements required to adjust the cutting disc is achieved, the cost of the adjustment mechanism being minimised and the speed to move the cutting disc from at least the inactive position to the active position being increased. The proposed machine is also safer by moving the cutting disc at least to the active position without the need for operator intervention, thus reducing possible injuries caused by handling a sharp cutting disc because the adjustment of the cutting disc is performed by the machine itself without human intervention when it is put into, also avoiding unwanted collisions (due to a bad adjustment for example) between the cutting disc and the auxiliary element, and reducing possible damage to these elements. The result is also a machine with higher availability.

These and other advantages and features will become apparent in view of the figures and the detailed description.

### BRIEF DESCRIPTION OF THE DRAWINGS

FIG. 1 shows a packaging machine according to one embodiment.

FIG. 2 shows a cutting assembly of the machine of FIG. 1 in perspective, with actuating means schematically depicted.

FIG. 3 shows in section the cutting assembly of FIG. 2, with the cutting disc in an inactive position.

FIG. 4 shows in section the cutting assembly of FIG. 2, with the cutting disc in an active position.

FIG. 5 partially shows and in section a cutting subassembly of the cutting assembly of FIG. 2 in the active position.

FIG. 6 partially shows and in section a cutting subassembly of the cutting assembly of FIG. 2 in the inactive position.

FIG. 7 schematically shows actuating means of an embodiment.

FIG. 8 schematically shows actuating means of an embodiment.

### DETAILED DESCRIPTION

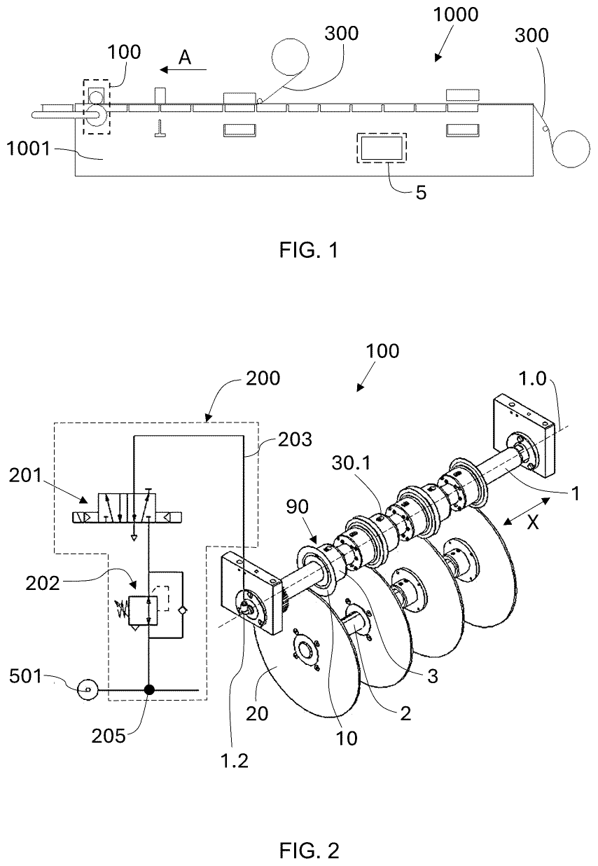

The proposed packaging machine 1000, as depicted by way of example in FIG. 1, comprises a cutting assembly 100 configured to longitudinally cut at least one continuous film 300, during the movement the film 300 in a forward direction A. In the machine 100 of FIG. 1, the packages are generated from a first film 300 serving as the base of the package and a second film 300 serving as the lid of the package, both films 300 being cut longitudinally.

As depicted in FIG. 2, the cutting assembly 100 comprises a rotary shaft 1 and the machine 1000 comprises an actuator not shown in the figures, for causing the rotary shaft 1 to rotate. The rotation of the rotary shaft 1 is caused at least during the advancement of the film 300, to perform the cutting of the film 300. The rotary shaft 1 rotates with respect to the longitudinal axis 1.0 when actuated and cannot move axially (at least when in use). Preferably the forward direction A is horizontal and the longitudinal axis 1.0 of the rotary shaft 1 is horizontal.

The cutting assembly 100 further comprises at least one cutting disc 10 which is associated with the rotary shaft 1 with a possibility of axial displacement between an active position and an inactive position, in an axial direction X, such that it rotates together with the rotary shaft 1 with respect to the longitudinal axis 1.0, when the rotary shaft 1 rotates; actuating means 200 configured to cause the axial displacement of the cutting disc 10; and at least one auxiliary member 20 configured to cooperate with the cutting disc 10 when the cutting disc 10 is in the active position. With said cooperation the film 300 is cut longitudinally as the film 300 advances in the forward direction A. Preferably the auxiliary member 20 is disc-shaped and in order to obtain a suitable cut of the film 300, the rotary shaft 1 is caused to rotate, and thus the cutting disc 10 to rotate, during the displacement of the film 300 in the forward direction A.

In some embodiments, the cutting assembly 100 comprises a rotary shaft 2 parallel to the rotary shaft 1 and rotating together with the rotary shaft 1 (see FIG. 2), either because it is attached to the rotary shaft 1 or by means of the same or a specific actuator configured to rotate it. In other embodiments not shown in the figures, the auxiliary member 20 may have other shapes than that of a disc. Regardless of the shape of the auxiliary member 20, in other embodiments not depicted in the figures, the cutting assembly 100 may comprise a support which may be attached to a frame 1001 of the machine 1000 and which is vertically facing the rotary shaft 1, and the auxiliary member 20 is attached to the support, or the auxiliary member 20 may be directly attached to the frame 1001.

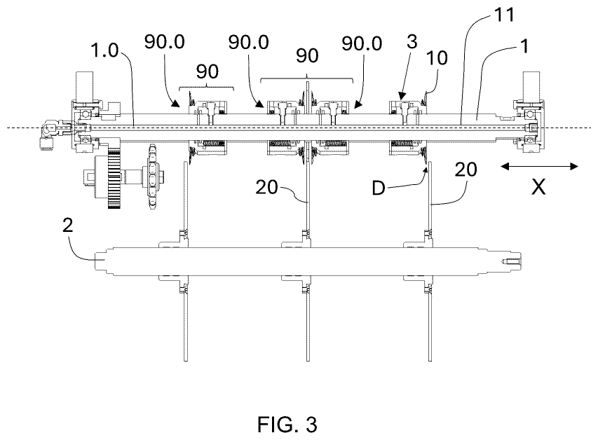

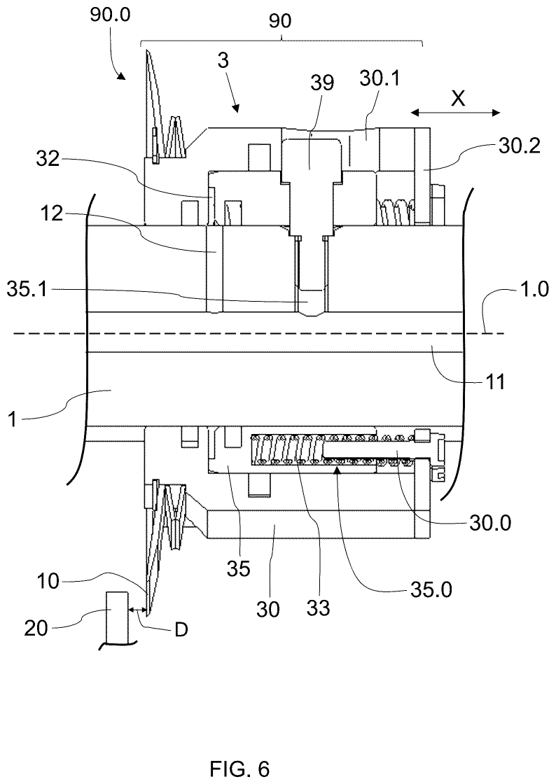

When the cutting disc 10 is in the inactive position (see FIGS. 3 and 6), an axial distance D between the cutting disc 10 and the auxiliary member 20 is such that they cannot cooperate with each other, and, moreover, the cutting disc 10 and the auxiliary member 20 are further prevented from colliding with each other and damaging each other, e.g. during maintenance work or during replacement of the cutting assembly 100.

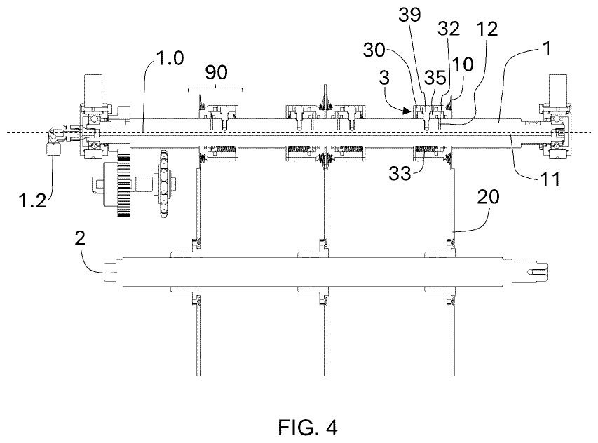

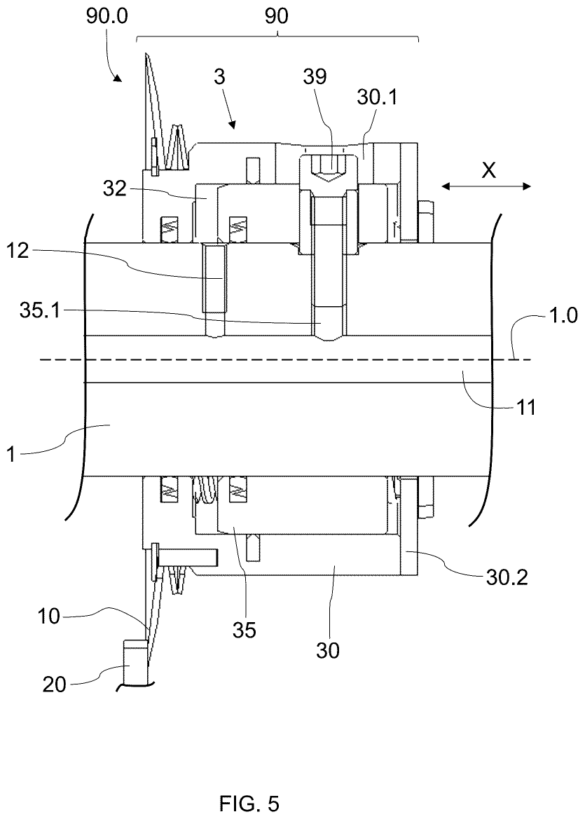

The cutting assembly 100 comprises a positioning mechanism 3 configured to cause the axial displacement of the cutting disc 10 with respect to the rotary shaft 1, at least to move from the inactive position to the active position (see FIGS. 4 and 5), and thereby decrease the axial distance D, to allow the cutting disc 10 and the auxiliary member 20 to cooperate with each other and longitudinally cut the film 300 as during its displacement in the forward direction A, the film 300 passes through the zone where the cutting disc 10 and the auxiliary member 20 cooperate.

The cutting assembly 100 comprises at least one cutting subassembly 90, and the cutting subassembly comprises at least one cutting block 90.0 comprising a positioning mechanism 3 and a cutting disc 10. The cutting assembly 100 may comprise a plurality of cutting subassemblies 90 associated with the first rotary shaft 1, and in that case the cutting assembly 100 comprises an auxiliary member 20 associated with each cutting subassembly 90. The cutting subassemblies 90 are axially distributed along the first rotary shaft 1, the auxiliary members 20 being distributed in the axial direction X parallel to the longitudinal axis 1.0. The actuating means 200 is in communication with the various cutting blocks 90.0 of the cutting subassemblies 90.

In some cases, where for example there is film 300 surplus between two packages or two contiguous cavities formed after the longitudinal cut (packages or cavities not depicted in the figures), a same cutting subassembly 90 performs the two longitudinal cuts between which said surplus remains, and the cutting subassembly 90 comprises two adjacent cutting blocks 90.0, one on each side of the associated auxiliary member 20 in the axial direction X. In such cases, the associated auxiliary member 20 is configured to cooperate simultaneously with the cutting discs 10 of the two corresponding cutting blocks 90.0 of the cutting subassembly 90. In other cases, where there is no film surplus 300 between two packages or two contiguous cavities formed after the longitudinal cut and in the case of cutting subassemblies 90 closer to the ends of the rotary shaft 1, the associated cutting subassembly 90 comprises a single cutting block 90.0.

The positioning mechanism 3 comprises a first positioning member 30 and a second positioning member 35, as shown in FIGS. 4 to 6. The second positioning member 35 is attached to the rotary shaft 1, without the possibility of relative displacement with respect to the rotary shaft 1, such that it rotates together with the rotary shaft 1, and the first positioning member 30 is associated with the second positioning member 35 with the possibility of axial displacement with respect to the rotary shaft 1, such that it rotates together with the second positioning member 35 but can also be displaced axially with respect to the second positioning member 35 (and thus with respect to the rotary shaft 1). The cutting disc 10 is attached to the first positioning member 30 such that it rotates with the first positioning member 30 when the first positioning member 30 rotates and moves axially with the first positioning member 30 with respect to the rotary shaft 1 when the first positioning member 30 moves axially with respect to the second positioning member 35 and thus with respect to the rotary shaft 1.

The positioning mechanism 3 also comprises a chamber 32 confined between the first positioning member 30 and the second positioning member 35 (see FIG. 5), such that the chamber 32 varies its volume when the first positioning member 30 is displaced axially with respect to the second positioning member 35. The actuating means 200 is configured for varying the volume of the chamber 32 when actuated, thereby modifying the pressure inside the chamber 32. The pressure change is preferably generated by changing the amount of fluid present in the chamber 32, either by introducing more fluid into the chamber 32 or by withdrawing fluid from the chamber 32. Preferably the fluid is air. By changing the pressure inside the chamber 32, the force exerted by the fluid in the chamber 32 on the positioning members 30 and 35 is changed, causing an axial displacement of the first positioning member 30 with respect to the second positioning member 35, thus axially displacing the cutting disc 10 with respect to the rotary shaft 1.

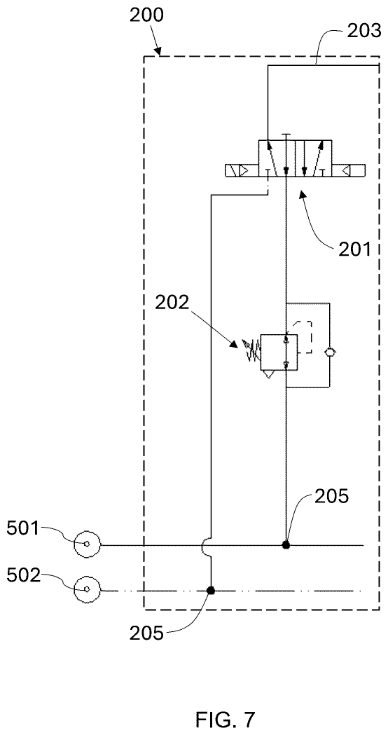

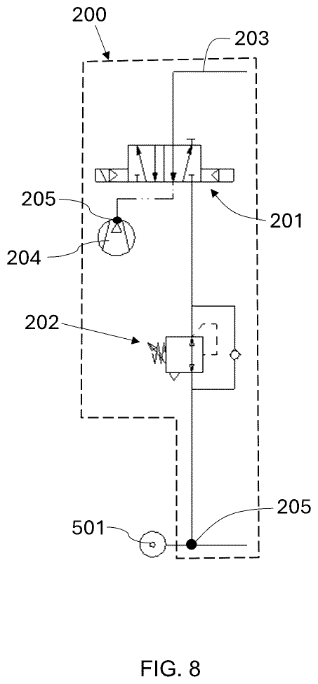

The pressure inside the chamber 32 can be increased by injecting more fluid into the chamber 32 or reduced by evacuating fluid from the chamber 32. The actuating means 200, depending on the embodiment of the machine 1000, is configured to only inject or extract fluid from the chamber 32 (see FIG. 2), or to inject fluid into the chamber 32 and extract fluid from the chamber 32 (see FIGS. 7 and 8). In the latter case, extraction and injection are not performed simultaneously.

The actuating means 200 comprise at least one connection 205 to be connected to a fluid pressure source 501, 502 to change the amount of fluid present within the chamber 32 with fluid from the pressure supply 501 or with fluid diverted to the pressure supply 502 from the chamber 32. The fluid pressure supply 501, 502 is an injection supply 501 such as a compressor or a pressurized fluid line for injecting fluid into the chamber 32, and the pressure supply 501, 502 is an extraction supply 502, such as a vacuum pump or an extraction line for extracting fluid from the chamber 32.

When the actuating means 200 comprise a single connection 205, the machine 1000 may comprise different configurations such as:
The machine 1000 comprises an injection supply, such as a compressor for example, connected to the connection 205, so that in use the machine 1000 is configured to change the amount of fluid in the chamber 32 by injecting fluid into the chamber 32 (configuration not shown in the figures).
The machine 1000 is configured to, in use, change the amount of fluid in the chamber 32 by injecting fluid into the chamber 32, the connection 205 being connected to an injection supply 501 external to the machine 1000, such as a pressurised fluid line (see FIG. 2).
The machine 1000 comprises an extraction supply, such as a vacuum pump for example, connected to the connection 205, so that in use the machine 1000 is configured to change the amount of fluid in the chamber 32 by extracting fluid from the chamber 32 (configuration not shown in the figures).
The machine 1000 is configured to, in use, change the amount of fluid in the chamber 32 by drawing fluid from the chamber 32, the connection 205 being connected to an extraction supply external to the machine 1000, such as an extraction line (configuration not shown in the figures).

The actuating means 200 comprise at least one controllable drive 201 arranged between the connection 205 and the chamber 32, and the machine 1000 comprises a control unit 5 configured to control actuation of the drive 201. The drive 201 is configured to open and close the fluidic communication between the connection 205 and the chamber 32 in a controlled manner when actuated by the control unit 5: when the fluidic communication is open and actuated, the drive 201 closes said communication; when the fluidic communication is closed and actuated, the drive 201 opens said communication. The drive 201 may comprise, for example, an electro valve.

In some embodiments, the actuating means 200 comprise a first connection 205 to be connected to a pressure supply 501 of fluid to change the amount of fluid present inside the fluid chamber 32 with fluid derived from the pressure supply 501 and a second connection 205 to be connected to a pressure supply 502 of fluid to change the amount of fluid present inside the fluid chamber 32 with fluid derived to the pressure supply 502 from the chamber 32. In these embodiments, in use, the machine 1000 is configured to change the amount of fluid in the chamber 32 by injecting fluid into the chamber 32 and by evacuating fluid from the chamber 32.

In these embodiments the machine 1000 may comprise different configurations such as:
With the machine 1000 in use, the first connection 205 is connected to an injection supply 501 external to the machine 1000 and the second connection 205 is connected to an extraction supply 502 external to the machine 1000 (see FIG. 7).
The machine 1000 comprises an extraction supply, such as a vacuum pump 204 for example, connected to the second connection 205, and with the machine 1000 in use, the first connection 205 is connected to an injection supply 501 external to the machine 1000 (see FIG. 8).
The machine 1000 comprises an injection supply, such as a compressor for example, connected to the first connection 205 and an extraction supply, such as a vacuum pump 204 for example, connected to the second connection 205 (configuration not shown in the figures).
The machine 1000 comprises an injection supply, such as a compressor for example, connected to the first connection 205 and, with the machine 1000 in use, the second connection 205 is connected to an extraction supply external to the machine 1000 (configuration not shown in the figures).

In these embodiments where the actuating means 200 comprise two connections 205, in some cases (not depicted in the figures) the actuating means 200 may have a first drive 201 connected between the chamber 32 and the first connection 205 and a second drive 201 connected between the chamber 32 and the second connection 205; but preferably comprise a drive 201 connected between the chamber 232 and the two connections 205 as depicted in the figures. In the latter case, the drive 201 keeps the fluidic communication between the first connection 205 and the chamber 32 open and keeps the fluidic communication between the second connection 205 and the chamber 32 closed while in a first position (see FIG. 7), and keeps the fluidic communication between the second connection 205 and the chamber 32 open and keeps the fluidic communication between the first connection 205 and the chamber 32 closed while in a second position (see FIG. 8).

In some embodiments, such as those shown in FIGS. 2, 7 and 8, the actuating means 200 comprise a pressure regulator 202 arranged between a connection 205 and the chamber 32, when the connection 205 is intended to be connected to an external injection supply 501, with the machine 1000 in use, or when connected to an injection source of the machine 1000 itself, the pressure regulator 202 being preferably arranged between the connection 205 and the drive 201.

The rotary shaft 1 comprises a hollow passage duct 11, and both the chamber 32 and the actuating means 200 are fluidly communicated with the passage duct 11. Preferably the passage duct 11 extends axially. Furthermore, the rotary shaft 1 comprises at least one distribution duct 12 extending from the passage duct 11 to the chamber 32 of the positioning mechanism 3, preferably in a radial direction with respect to the longitudinal axis 1.0. Thus, the actuating means 200 is fluidically communicated with the chamber 32 at least via the passage duct 11 and the distribution duct 12.

The actuating means 200 comprises a connection duct 203 which fluidically communicates the passage duct 11 with the connection 205, in particular the passage duct 11 with the drive 201 (or with the drives 201), and the cutting assembly 100 comprises a connector 1.2. Unlike the rotary shaft 1, the connection duct 203 is not rotatable with respect to the longitudinal axis 1.0, the connector 1.2 being configured to prevent transmission of the rotation of the rotary shaft 1 to the connection duct 203.

In some embodiments of the machine 1000, the cutting device 100 comprises a chamber 32 of an elastic material, preferably in the form of a toroid or the like, comprising a nozzle connected to the distribution duct 12 for swelling/deflating, for example, although preferably the chamber 32 does not comprise such elastic material for such delimitation. In the latter case, preferably, the chamber 32 is bounded directly between the rotary shaft 1 and the two positioning members 30 and 35, to one side in the axial direction X of the second positioning member 35, it being axially bounded between the two positioning members 30 and 35. When the fluid is injected, for example, when more fluid is introduced into the chamber 32, this new fluid directly exerts a force against the elements that delimit the chamber 32, causing the axial displacement of the first positioning member 30 with respect to the rotary shaft 1 (since the second positioning member 35 is attached to the rotary shaft 1 without the possibility of axial displacement).

Preferably the first positioning member 30 defines an inner recess, and the second positioning member 35 is housed in the inner recess. The first positioning member 30 may further comprise a cover 30.2 on the axial side opposite the cutting disc 10 (see FIGS. 5 and 6), the second positioning member 35 being enclosed between the inner recess of the first positioning member 30 and the cover 30.2. The chamber 32 houses part of the inner recess.

As previously described, the first positioning member 30 is attached to the second positioning member 35 with the possibility of axial displacement and the second positioning member 35 is attached to the rotary shaft 1. Preferably the second positioning member 35 comprises a through radial bore 35.1 and the positioning mechanism 3 comprises a transmission rod 39 associated with the rotary shaft 1 and rotating with the rotary shaft 1, preferably a screw, which is arranged in the through radial bore 35.1 and through which the second positioning member 35 is connected to the rotary shaft 1, such that the rod 39 transmits the rotation of the rotary shaft 1 and to the second positioning member 35. The first positioning member 30 comprises a groove 30.1 extending parallel to the longitudinal axis 1.0 and configured to housing the rod 39, such that the rod 39 transmits the rotation of the rotary shaft 1 to the positioning member 30 as the groove 30.1 is traversed by the rod 39 and associates the first positioning element 30 with the second positioning element 35. The groove 30.1 comprises a length in the axial direction X greater than the width of the rod 39, thus allowing axial displacement of the first positioning member 30 with respect to the rotary shaft 1 (and with respect to the second positioning member 35).

In some embodiments, the adjustment mechanism 3 comprises a spring 33 arranged on one side, in the axial direction X, of the second positioning member 35, the axial side preferably being the side opposite to the side on which the chamber 32 is located. The spring 33 is associated with the first positioning member 30 and the second positioning member 35 and is arranged in such a way that it exerts a force against the first positioning member 30 contrary to the force exerted by the fluid on the first positioning member 30 as an effect of the actuation of the actuating means 200. This makes possible that, when the force exerted by the spring 33 in the axial direction X against both positioning members 30 and 35 is greater than the force resulting from the pressure exerted by the fluid in the chamber 32 (for example when the actuating means 200 are no longer actuated), thanks to the force of the spring 33 the first positioning member 30 returns to the inactive position, increasing the axial distance D between the cutting disc 10 and the auxiliary member 20 with the advantages that this entails and which have been described previously. In these embodiments, the actuating means 200 are configured to move the cutting disc 10 to both the active position and the inactive position.

As shown in FIG. 6, preferably one of the positioning members 30 and 35 comprises a housing 35.0 where the spring 33 is housed and the other positioning member 30 and 35 comprises a guide 30.0 or protrusion configured to be inserted into the spring 33 (surrounded by the coils of the spring 33), which allows easy mounting of the spring 33. Thanks to the cover 30.2, which is removable, the inner recess of the first positioning member 30 can be accessed to perform such mounting in a simple manner. The guide 30.0 or protrusion can be part of the corresponding positioning member 30 and 35 or be attached to the corresponding positioning member 30 and 35. Preferably, the second positioning member 35 comprises the housing 35.0 and the first positioning member 30 comprises the guide 30.1. In this case the guide 30.0 would preferably be associated with the cover 30.2. Preferably the spring 33 is deformed at all times such that it exerts a force in the axial direction of the rotary shaft 1, both in the active and in the inactive position of the cutting disc 10. This ensures that the cutting disc 10 moves to the inactive position when appropriate.

1. A packaging machine comprising a cutting assembly configured to longitudinally cut a film during a displacement of the film in a forward direction, the cutting assembly comprising:
a rotary shaft with a longitudinal axis transverse to the forward direction;
a cutting disc that is coupled to and rotates with the rotary shaft, the cutting disc being axially displaceable with respect to the rotary shaft between an inactive position and an active position;
an auxiliary member configured to cooperate with the cutting disc to cut the film when the cutting disc is in the active position; and
a positioning mechanism configured to cause axial displacement of the cutting disc with respect to the rotary shaft at least to position the cutting disc in the active position, the positioning mechanism comprising:
a first positioning member coupled to the cutting disc such that the first positioning member and the cutting disc are together axially displaceable with respect to the rotary shaft;
a second positioning member coupled to the rotary shaft without the possibility of relative displacement with respect to the rotary shaft;
a chamber confined between the first positioning member and the second positioning member, the positioning mechanism being configured such that when a pressure inside the chamber is modified the first positioning member is axially displaced with respect to the rotary shaft so that the cutting disc at least passes from the inactive position to the active position.

2. The packaging machine according to claim 1, comprising an actuator that is configured to inject and/or evacuate a fluid from the chamber to modify the pressure inside the chamber.

3. The packaging machine according to claim 2, wherein the fluid is air.

4. The packaging machine according to claim 2, wherein the actuator includes a controllable drive that is transitional between a closed position and an open position, in the open position the chamber is in fluid communication with a fluid pressure supply, in the closed position the chamber is not in fluid communication with the fluid pressure supply.

5. The packaging machine according to claim 4, wherein the controllable drive is an electrically controlled valve that is controlled by a control unit of the packaging machine.

6. The packaging machine according to claim 2, wherein the fluid pressure supply is a compressor and/or a vacuum pump.

7. The cutting assembly according to claim 1, comprising an actuator that is configured to inject and evacuate a fluid from the chamber to modify the pressure inside the chamber, the actuator including a first fluid pressure supply for injecting the fluid into the chamber and a second fluid pressure supply for evacuating the fluid from the chamber.

8. The packaging machine according to claim 7, comprising a controllable drive that is transitional between a first position and a second position, when the controllable drive is in the first position the chamber is in fluid communication with the first fluid pressure supply and not the second fluid pressure supply, when the controllable drive is in the second position the chamber is in fluid communication with the second fluid pressure supply and not the first fluid pressure supply.

9. The packaging machine according to claim 8, wherein the first fluid pressure supply is a compressor and the second fluid pressure supply is a vacuum pump.

10. The packaging machine according to claim 4, wherein the actuator comprises a pressure regulator arranged between the fluid pressure supply and the chamber.

11. The packaging machine according to claim 2, wherein the rotary shaft comprises a hollow passage duct extending in a direction of the longitudinal axis, and at least one distribution duct extending radially from the hollow passage duct to the chamber, such that the actuator fluidly communicates with the chamber at least via the hollow passage duct and the at least one distribution duct.

12. The packaging machine according to claim 11, wherein the actuator comprises a connection duct that fluidly communicates with the hollow passage duct of the rotary shaft, the cutting assembly including a connector configured to connect the connection duct to the hollow passage duct and configured to prevent transmission of rotation of the rotary shaft to the connection duct.

13. The packaging machine according to claim 1, wherein the chamber is bounded between the rotary shaft and the first and second positioning members.

14. The packaging machine according to claim 13, wherein the chamber is located in an axial direction on one side of the second positioning member.

15. The packaging machine according to claim 14, wherein the positioning mechanism comprises a spring associated with the first positioning member and the second positioning member, such that the spring exerts a force in the axial direction of the rotary shaft against both the first and second positioning members causing the displacement of the first positioning member in the axial direction when the force is greater than a force resulting from a pressure exerted by the fluid in the chamber, the spring being arranged on one side in the axial direction of the second positioning member.

16. The packaging machine according to claim 15, wherein one of the first and second positioning members comprises a housing in which the spring resides, and the positioning mechanism includes a guide associated with the other of the first and second positioning member and configured to be at least partially inserted in the spring and in the housing.

17. The packaging machine according to claim 15, wherein the spring continuously exerts a force in the axial direction of the rotary shaft when the cutting disc is in the inactive position and the active position.

18. The packaging machine according to claim 1, wherein the positioning mechanism comprises a transmission rod associated with the rotary shaft, which rotates with the rotary shaft, and the first positioning member includes a groove extending parallel to the longitudinal axis of the rotary shaft and which is configured to housing the transmission rod, such that the transmission rod transmits the rotation of the rotary shaft to the first positioning member, the groove being configured to allow axial displacement of the first positioning member with respect to the rotary shaft.

19. The packaging machine according to claim 18, wherein the transmission rod connects the second positioning member and the rotary shaft in such a way that the transmission rod transmits the rotation of the rotary shaft to the second positioning member.

20. The packaging machine according to claim 2, wherein the cutting assembly comprises a plurality of cutting subassemblies associated with the first rotary shaft and an auxiliary member associated with each cutting subassembly, each cutting subassembly comprising at least one cutting block with a positioning mechanism and a cutting disc and the cutting subassemblies being axially distributed along the first rotary shaft and sharing the same actuator.
